(19) United States
(12) Patent Application Publication
(10) Pub. No.: US 2005/0206174 A1
(43) Pub. Date: Sep. 22, 2005

(54) Latch mechanism

(76) Inventor: Sidney Edward Fisher, Redditch (GB)

Correspondence Address: CARLSON, GASKEY & OLDS, P.C., 400 WEST MAPLE ROAD, SUITE 350, BIRMINGHAM, MI, 48009, US

(21) Appl. No.: 11/083,359

(22) Filed: Mar. 17, 2005

(30) Foreign Application Priority Data
Mar. 18, 2004 (EP) 04251547.8

(51) Int. Cl. E05C 3/06

(52) U.S. Cl. 292/226

(57) ABSTRACT

A latch mechanism includes a release lever and a lock lever arranged for rotation about a common axis of rotation. The release lever has a first position and a second position which correspond to a first position and a second position, respectively, of the lock lever. The release lever has a third position. Relative rotation between the release lever and the lock lever is prevented when the release lever and the lock lever are moved between their first and second positions. When the release lever in the third position, the release member is biased towards its second position by a resilient member. The first positions of the release lever and the lock lever correspond to a locked status of the latch mechanism, the second positions of the release lever and lock lever correspond to an unlocked status of the latch mechanism, and the third position of the release lever correspond to a released status of the latch mechanism.

### REFERENCE TO RELATED APPLICATIONS

This patent application claims priority to European Patent Application No. EP 04251547.8 filed on Mar. 18, 2004.

### BACKGROUND OF THE INVENTION

The present invention relates generally to a latch mechanism for use in particular in door latches of passenger vehicles, such as cars.

Known latches for passenger vehicles typically release and retain a door so that it may open and close and lock and unlock. The latch may also superlock the door. To perform these multiple functions, the latch must have a release lever which permits opening of the door from inside or outside the vehicle and a lock lever for locking and unlocking the door from inside or outside the vehicle.

Usually, the lock lever is operated from outside the vehicle by a key barrel and from inside the vehicle by a sill button. In the majority of vehicles, the release lever will be operated from inside and outside the vehicle by respective inside and outside release handles.

However, in some cases, the release lever and the lock lever are operated from inside the vehicle by a single handle. This concept is known as push pull locking with override release. In such a latch, the release lever and the lock lever are required to act in conjunction with one another so that movement of the door handle from a first position to a second position unlocks the latch, and further movement of the door handle to a third position releases the latch. The latch may have either single pull override release or double pull override release.

There are various known methods of providing a latch with a latch mechanism which enables mechanical engagement between the release lever and the lock lever. For example, in GB2300667, the release lever and the lock lever are mounted for rotation on separate shafts, and all the levers are linked by a Bowden cable arrangement. However, such a latch mechanism is costly to manufacture and is possibly liable to component failure as a result of the complexity of the design.

### SUMMARY OF THE INVENTION

It is an object of the present invention to provide an improved latch mechanism.

According to the invention, a latch mechanism includes a release lever and a lock lever arranged for rotation about a common axis of rotation. The release lever has a first position and a second position which correspond to a first position and a second position, respectively, of the lock lever. The release lever has a third position. Relative rotation between the release lever and the lock lever is prevented when the release lever and the lock lever are moved between their first positions and their second positions. When the release lever in the third position, the release lever is biased towards the second position by a resilient member. The first positions of the release lever and the lock lever correspond to a locked status of the latch mechanism, the second positions of the release lever and the lock lever correspond to an unlocked status of the latch mechanism, and the third position of the release lever corresponds to a released status of the latch mechanism.

The latch is advantageous over the prior art because the release lever and the lock lever are mounted for rotation at a single location. This reduces the number of components required for manufacture, thereby reducing cost. Furthermore, the latch mechanism is less likely to fail because the complexity of the design is greatly reduced.

A benefit of the present invention is that the lock lever and the release lever may operate in fixed mechanical relation. Where the release lever is attached to an inside release handle, for example, the inside release handle may be used to lock and unlock the latch since the release lever is in fixed mechanical relation to the lock lever. A sill button in addition to a release handle within the vehicle passenger compartment is then not required. Preferably, the resilient member biases the release lever towards the second position.

Preferably, this feature allows the inside release handle to be returned to the rest unlocked position under the force of the resilient member once the inside release handle has been released by the vehicle occupant.

According to a second aspect of the invention, the latch further includes a release cross lever in separable driven communication with the release lever and a cross lock lever in mechanical engagement with the lock lever. The release cross lever is moveable to open the latch, and the lock cross lever is moveable to lock and unlock the latch.

### BRIEF DESCRIPTION OF THE DRAWINGS

The invention will now be described, by way of example only, with reference to the accompanying drawings in which:

FIG. 1 is a front view of a latch mechanism of the present invention showing a release lever and a lock lever in their first locked positions;

FIG. 2 shows the latch mechanism of FIG. 1 with the lock lever and the release lever in their second unlocked positions;

FIG. 3 shows the latch mechanism of FIG. 1 with the lock lever in its second unlocked position and the release lever in a third released position;

FIG. 4 is an isometric exploded top view of the latch mechanism of FIG. 1;

FIG. 5 is an isometric exploded bottom view of the latch mechanism of FIG. 1;

FIG. 6 is a front view of a second embodiment of a latch mechanism of the present invention with the lock lever and the release lever in their first locked positions;

FIG. 7 shows the latch mechanism of FIG. 6 with the lock lever and the release lever in their second unlocked positions;

FIG. 8 shows the latch mechanism of FIG. 6 with the lock lever in the second unlocked position and the release lever in a third released position; and

FIG. 9 is an exploded front view of the latch mechanism of FIG. 6.

### DETAILED DESCRIPTION OF THE PREFERRED EMBODIMENT

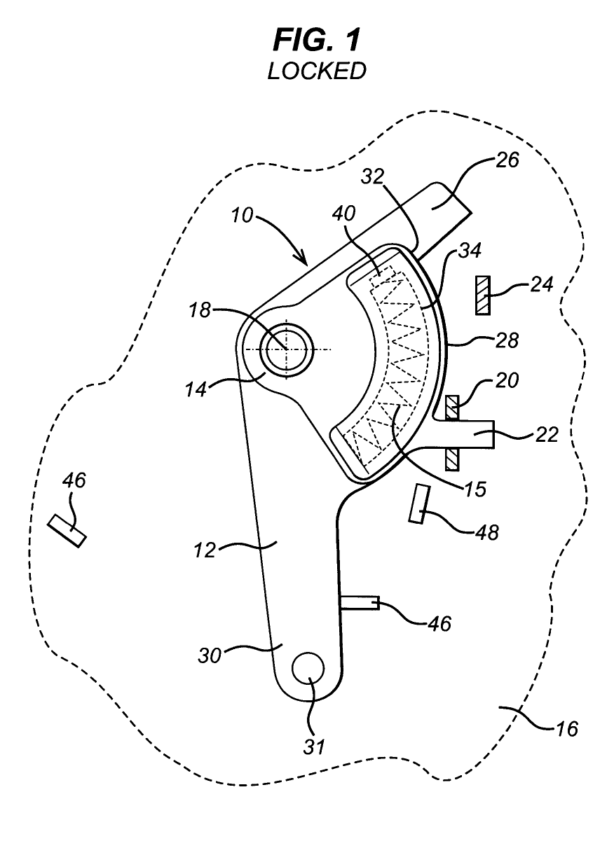

FIGS. 1 to 3 show a latch mechanism 10 (only part of which is shown) having a release lever 12 and a lock lever 14. The release lever 12 and the lock lever 14 are rotationally mounted to a latch chassis 16 (shown schematically in FIG. 1 only, for clarity) about an axis of rotation 18. The release lever 12 and the lock lever 14 are mounted to the latch chassis 16 so as to be capable of rotating with respect to the latch chassis 16, as well as relative to one another.

In use, the latch mechanism 10 forms part of a vehicle door latch. The release lever 12 is attached via a transmission path to a pawl (not shown). When the door is latched, the pawl blocks rotation of a rotatable latch claw (not shown), which in turn retains a striker (not shown). The striker is arranged on the vehicle body to latch the door shut. Operation of a release handle causes the pawl to disengage the claw, which in turn releases the striker, opening the door.

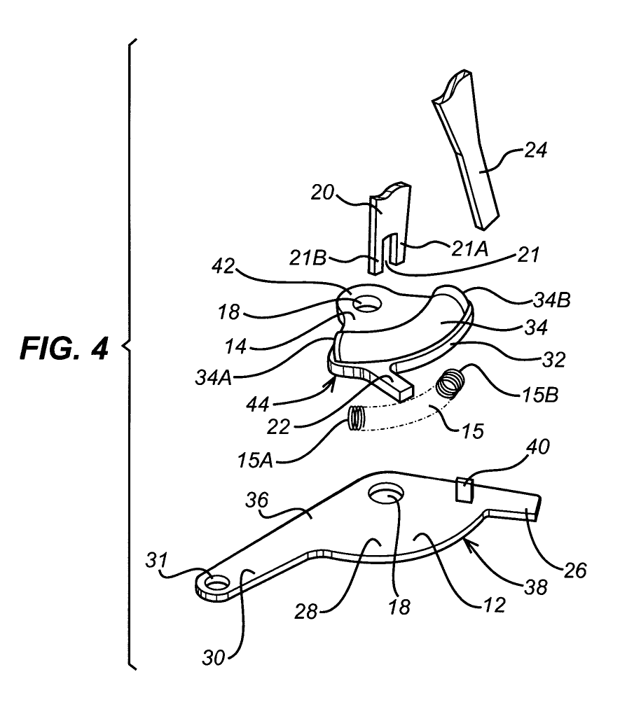

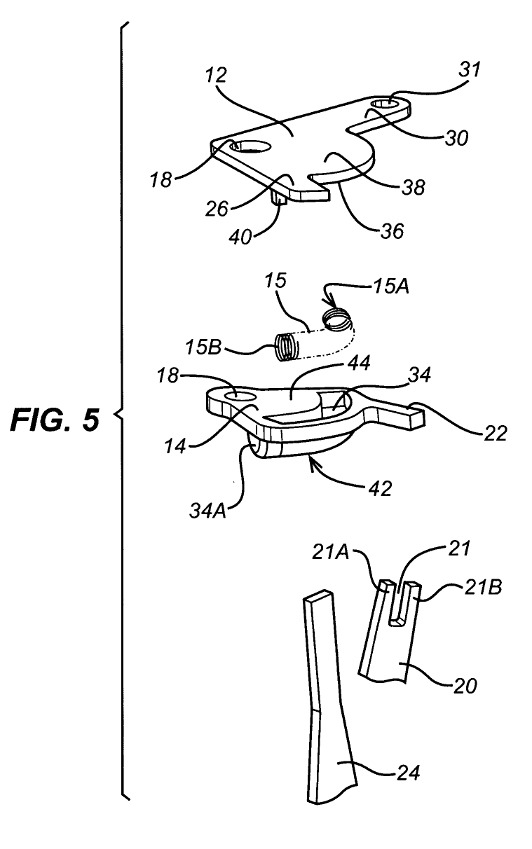

The release lever 12 has an arcuate portion 28 (shown in detail in FIGS. 4 and 5) which has a radius centered on the axis of rotation 18. A cross release arm 26 is arranged on one side of the arcuate portion 28, and a release arm 30 is arranged on the opposite side of the arcuate portion 28. The release arm 30 has a hole 31 which allows the release arm 30 to be attached via a cable, or similar arrangement, to an inside release handle (not shown).

The lock lever 14 also defines an arcuate portion 32, the radius of which is centered on the axis of rotation 18. A cross lock arm 22 is arranged at one end of the arcuate portion 32, and an arcuate channel 34 is arranged at a periphery of the arcuate portion 32.

The release lever 12 includes an upper surface 36 and a lower surface 38. The upper surface 36 has a lug 40 near the cross release arm 26. The lock lever 14 has an upper surface 42 and a lower surface 44. The lower surface 44 of the lock lever 14 and the upper surface 36 of the release lever 12 are substantially flat in profile to form a flush interface therebetween.

A compression spring 15 is arranged within the arcuate channel 34 of the lock lever 14 such that a first end 15A of the compression spring 15 abuts a first end 34A of the arcuate channel 34. The lug 40 of the release lever 12 is located within the arcuate channel 34 proximate a second end 34B of the arcuate channel 34. A second end 15B of the compression spring 15 abuts the lug 40.

During manufacture, the compression spring 15 may be formed with an arcuate longitudinal axis when in a free state to minimize stresses within the compression spring 15. The arcuate axis is achieved either by heat treatment or by applying a controlled twist to the wire during formation of the compression spring 15.

A cross lock lever 20 engages the cross lock arm 22 of the lock lever 14. The cross lock lever 20 is attached to a lock mechanism (not shown) via a transmission path.

The cross lock lever 20 includes a fork 21 which defines two tines 21A and 21B. The cross lock arm 22 is arranged between the tines 21A and 21B. As a result, movement of the lock lever 14 in either direction between locked and unlocked moves the cross lock lever 20. When the lock lever 14 is moved from a locked status to an unlocked status, the cross lock arm 22 will engage the first tine 21A, and when the lock lever 14 is moved from unlocked status to locked status, the cross lock arm 22 will engage the second tine 21B.

Since the cross lock lever 20 is in mechanical engagement with a lock mechanism, the lock mechanism may be actuated by movement of the lock lever 14 via the cross lock lever 20. Alternatively, the lock mechanism (and consequently the lock lever 14) might be actuated by a central locking system (not shown).

Similarly, a cross release lever 24 is provided for engagement with the cross release arm 26 of the release lever 12. The cross release lever 24 is in mechanical engagement with the pawl of a release mechanism (not shown). Consequently, movement of the release lever 12 is capable of actuating the release mechanism.

Returning now to FIGS. 1 to 3, release arm stops 46 and a cross lock arm stop 48 are attached to the latch chassis 16 and in fixed relation to the axis of rotation 18. The cross lock arm stop 48 prevents movement of the cross lock arm 22 past its unlocked position. The release arm stops 46 prevent movement of the release arm 30 past its first locked position and past its third released position.

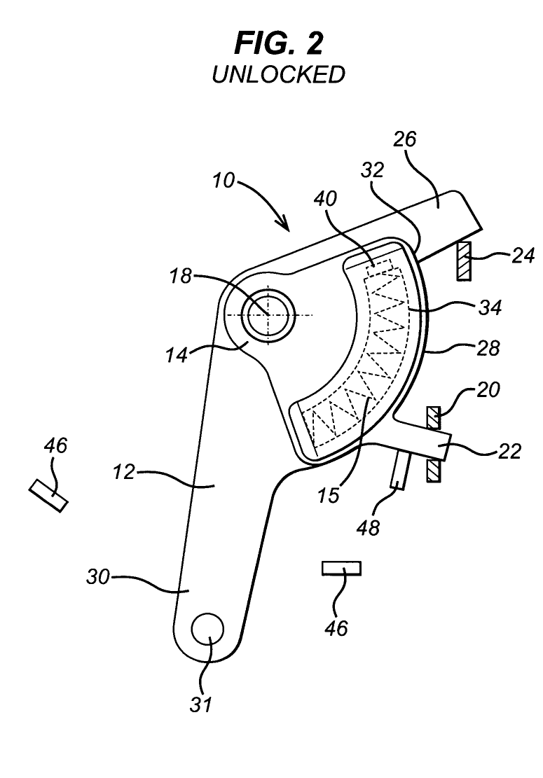

In use, the latch may be moved between the locked status (as shown in FIG. 1) and the unlocked status (as shown in FIG. 2) by movement of the cross lock arm 22. Such movement may be effected either by operation of a central lock motor, a key barrel or an override release handle.

Operation of the latch will now be described with reference to FIGS. 1 to 3. When the release lever 12 is operated via the inside release handle with the latch mechanism 10 in the locked status (FIG. 1), the lug 40 rotates with the release arm 30 about the axis of rotation 18. This causes the lug 40 to act on the second end 15B of the compression spring 15. Since the compression spring 15 is pre-loaded, the action of the lug 40 on the compression spring 15 does not compress the compression spring 15, but instead the lock lever 14 rotates by virtue of its abutment with the first end 15A of the compression spring 15 to the unlocked position. In this manner, the latch mechanism 10 is unlocked by operation of the release lever 12, which is in turn attached to the inside door handle.

It is equally possible to move the latch mechanism 10 from the unlocked status to the locked status by movement of the release lever 12 in the opposite direction. This operation causes the lug 40 to act on the second end 34B of the arcuate channel 34, which rotates the lock lever 14 from the position shown in FIG. 2 to the position shown in FIG. 1.

In addition to the latch mechanism 10 being locked and unlocked via actuation of the release lever 12, it is also possible to move the latch between the locked status and the unlocked status by the cross lock lever 20 acting on the cross lock arm 22. In this manner, the latch mechanism 10 may be moved between the locked status and the unlocked status by actuation of, for example, a central locking system or a key barrel which would operate the cross lock lever 20 via a transmission path (not shown).

The latch mechanism 10 may be moved repeatedly between the locked status and the unlocked status as shown in FIGS. 1 and 2, respectively either by operation of the release lever 12 or the cross lock lever 20.

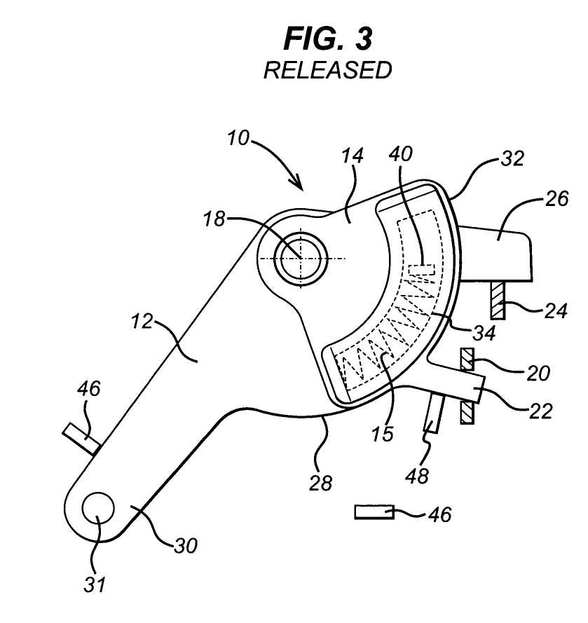

As described above, movement of the cross lock lever 20 from the locked position (FIG. 1) to the unlocked position (FIG. 2) brings the cross release arm 26 into contact with the cross release lever 24. Further movement of the release arm 30 to the release position shown in FIG. 3 causes the cross release arm 26 to move the cross release lever 24 to the released position. The cross lock lever 24 is attached, via a transmission path, to the pawl (not shown). Consequently, movement of the cross release lever 24 releases the latch. Furthermore, moving the release lever 12 from the unlocked position (FIG. 2) to the released position (FIG. 3) causes the lug 40 to act on the compression spring 15. Since the cross lock arm stop 48 prevents rotation of the lock lever 14, the compression spring 15 compresses. As a result, when the operation of the release arm 30 is stopped, the compression spring 15 expands to return the release lever 12 to the unlocked position, shown in FIG. 2.

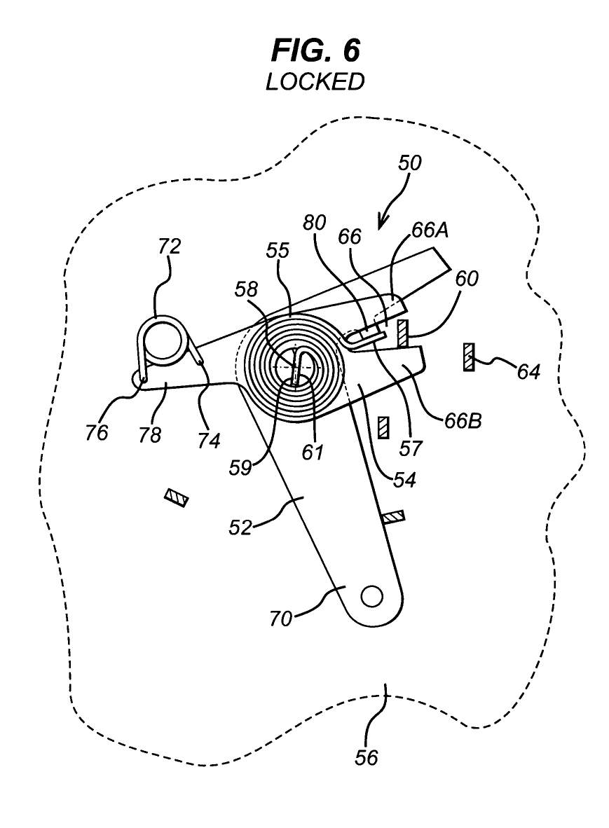

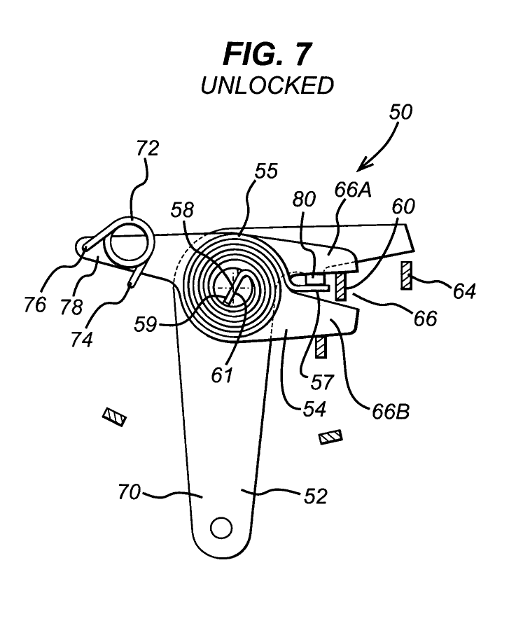

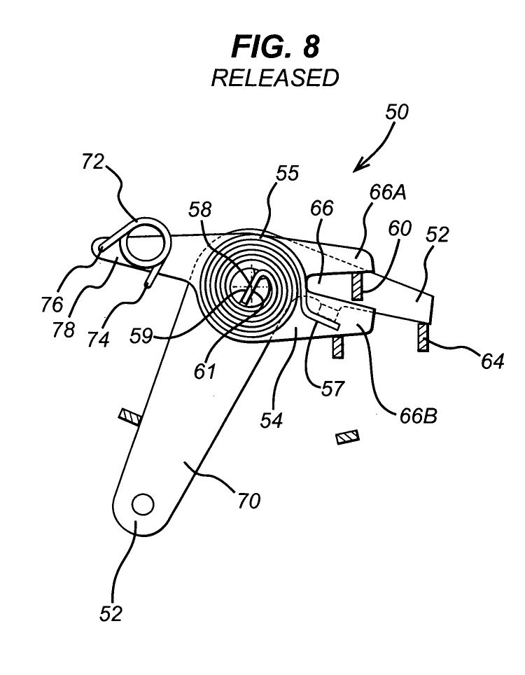

A second embodiment of the invention, in the form of a latch mechanism 50 as shown in FIGS. 6 to 8, includes a release lever 52 and a lock lever 54 arranged similarly to the first embodiment. Both the release lever 52 and the lock lever 54 are mounted on a latch chassis 56 such that they have a common axis of rotation 58. In contrast to the first embodiment, the latch mechanism 50 includes a spiral spring 55 which has a coil center substantially in the same position as the axis of rotation 58. The spiral spring 55 resiliently allows relative movement between the lock lever 54 and the release lever 52 when the release lever 52 is operated to release the latch (see FIG. 8). With the release lever 52 in a transient released position (FIG. 8), the spiral spring 55 biases the release lever 52 to return to an unlocked position (FIG. 7).

In the first embodiment, the cross lock lever 20 defines a fork 21 having two tines 21A and 21B between which the cross lock arm 22 of the lock lever 14 acts. In the second embodiment, the lock lever 54 defines a fork 66 which has tines 66A and 66B, with the cross lock lever 60 acting between the tines 66A and 66B. The two arrangements are operationally similar, the difference being that the fork 66 is defined by a different component in each embodiment.

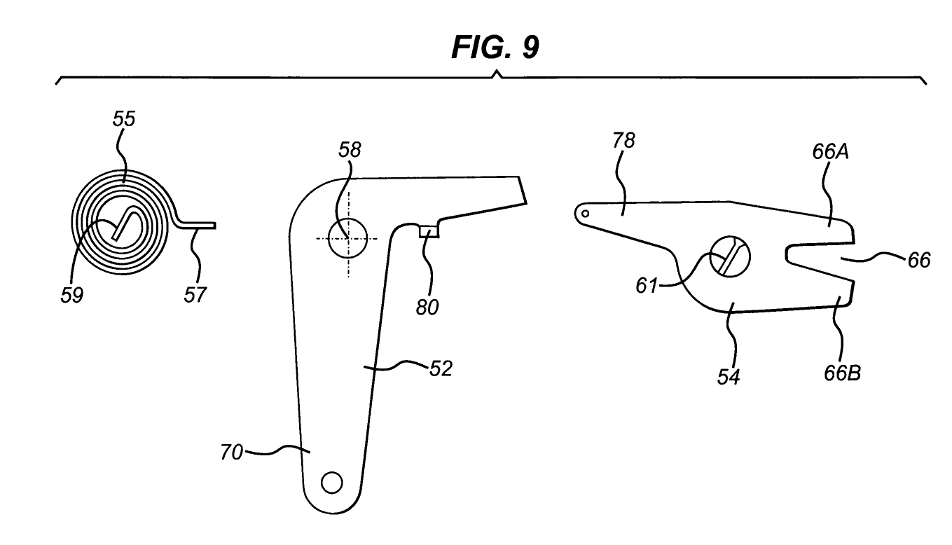

In FIG. 9, the release lever 52 includes a release arm 70 and a cross release arm 66. A lug 80 is located on the inside of the cross release arm 66. The lug 80 abuts an outer end 57 of the spiral spring 55. An inner end 59 of the spiral spring 55 sits in a groove 61 of the lock lever 54. The center of the spiral spring 55 is centered on the common axis of rotation 58.

With reference once again to FIGS. 6 to 8, the latch mechanism 50 is further provided with an over-center spring 72 having a first end 74 attached to the latch chassis 56 and a second end 76 attached to an over-center arm 76 of the lock lever 54.

In use, the second embodiment operates in a similar manner to the first embodiment. Furthermore, it is conceivable that many of the features of the first and second embodiments are interchangeable. For example, the lock lever 14 of the first embodiment may include an over-center arm similar to that of the second embodiment to receive an over-center spring which is attached to the latch chassis in a similar fashion to the second embodiment.

It is conceivable within the scope of the invention that the over-center spring may take the form of a leaf spring or other resilient member, and could in fact be mounted elsewhere on the lock lever to provide a resilient over-center relative motion between the lock lever and the latch chassis.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A latch mechanism comprising:
a lock lever having a first lock lever position and a second lock lever position; and
a release lever having a first release lever position and a second release lever position which correspond to the first lock lever position and the second lock lever position, respectively, and a third release lever position,
wherein the release lever and the lock lever rotate about a common axis of rotation, and relative rotation between the release lever and the lock lever is prevented when the release lever and the lock lever are moved between the first release lever position and the first lock lever position, respectively, and the second release lever position and the second lock lever position, respectively,
wherein the release lever is biased towards the second release lever position by a resilient member when in the third release lever position, and
wherein the first release lever position and the first lock lever position correspond to a locked status of the latch mechanism, the second release lever position and the second lock lever position correspond to an unlocked status of the latch mechanism, and the third release lever position corresponds to a released status of the latch mechanism.

2. The latch mechanism according to claim 1 wherein the resilient member operably acts between the release lever and the lock lever to bias the release lever towards the second release lever position when the release lever in the third release lever position.

3. The latch mechanism according to claim 1 wherein the release lever defines an abutment that engages the lock lever to move the lock lever from the second lock lever position to the first lock lever position.

4. The latch mechanism according to claim 3 wherein the resilient member further includes a first end, and the abutment engages the first end of the resilient member.

5. The latch mechanism according to claim 1 wherein the resilient member is a compression spring.

6. The latch mechanism according to claim 5 wherein the compression spring includes an arcuate longitudinal axis when in a free state.

7. The latch mechanism according to claim 1 wherein the lock lever defines an arcuate channel for housing the resilient member.

8. The latch mechanism according to claim 7 wherein the arcuate channel includes a channel end having an abutment and the resilient member includes a resilient member end, wherein the abutment abuts the resilient member end of the resilient member.

9. The latch mechanism according to claim 1 wherein the resilient member is a spiral spring.

10. The latch mechanism according to claim 9 wherein the spiral spring includes an end and the lock lever defines a groove for receiving the end of the spiral spring.

11. The latch mechanism according to claim 9 wherein the spiral spring has a coil center coaxial with the axis of rotation of the lock lever and the release lever.

12. The latch mechanism of claim 1 wherein a lock lever intermediate position is defined between the first lock lever position and the second lock lever position and a release lever intermediate position is defined between the first release lever position and the second release lever position, wherein the latch mechanism includes a biasing member which biases the lock lever and the release lever to one of the first lock lever position and the first release lever position, respectively, and the second lock lever position and the second release lever position, respectively, and away from the lock lever intermediate position and the release lever intermediate position, respectively.

13. The latch mechanism according to claim 12 wherein the biasing member is a coil spring.

14. The latch mechanism according to claim 1 wherein the lock lever and the release lever define a common interface which are substantially flat.

15. A latch comprising:
a latch mechanism including:
a lock lever having a first lock lever position and a second lock lever position, and
a release lever having a first release lever position and a second release lever position which correspond to the first lock lever position and the second lock lever position, respectively, and a third release lever position,
wherein the release lever and the lock lever rotate about a common axis of rotation, and relative rotation between the release lever and the lock lever is prevented when the release lever and the lock lever are moved between the first release lever position and the first lock lever position, respectively, and the second release lever position and the second lock lever position, respectively,
wherein the release lever is biased towards the second release lever position by a resilient member when in the third release lever position, and
wherein the first release lever position and the first lock lever position correspond to a locked status of the latch mechanism, the second release lever position and the second lock lever position correspond to an unlocked status of the latch mechanism, and the third release lever position corresponds to a released status of the latch mechanism;
a release cross lever in separable driven communication with the release lever; and
a lock cross lever in mechanical engagement with the lock lever, wherein the release cross lever is moveable to open the latch, and the lock cross lever is moveable to lock and unlock the latch.
